(19) United States
(12) Patent Application Publication
(10) Pub. No.: US 2019/0242537 A1
(43) Pub. Date: Aug. 8, 2019

(54) SEPARABLE RECHARGE NIGHTLIGHT

(71) Applicant: Hua-Cheng Pan, Tainan City (TW)

(72) Inventor: Chih-Liang Wang, Tainan City (TW)

(21) Appl. No.: 15/889,227

(22) Filed: Feb. 6, 2018

(51) Int. Cl. F21L 4/08; F21V 23/02; F21V 23/00; F21V 23/04; H05B 37/02; H02J 7/00

(52) U.S. Cl. CPC F21L 4/08; F21V 23/02; F21V 23/003; H02J 7/345; F21V 23/0442; H05B 37/0209; H02J 7/0068; F21V 23/0414

(57) ABSTRACT

A separate rechargeable night light, which mainly includes: a nightlight holder and a lighting fixture; wherein the nightlight holder is set with an electricity contact terminal for contacting to the mains supply, a rectifier circuit, and a first contact switch. The lighting fixture is set with a charge-discharge circuit and a second contact switch. The charge-discharge circuit includes a light-emitting element. The lighting fixture can be separately connected to the first contact switch through the second contact switch, whereby the lighting fixture can be used separately to achieve the effect of moving with the user.

### (A) TECHNICAL FIELD OF THE INVENTION

The present invention relates to a nightlight, especially relates to a lighting fixture structure which can be used separately.

### (B) DESCRIPTION OF THE PRIOR ART

The general purpose of the nightlight is mainly to provide night or indoor lighting in the dark, so that people walking around, will not hit or kick anything, causing dangerous things happen.

In addition, the nightlight also creates the effect of the indoor atmosphere. Therefore, the industry have successively developed various special-shaped nightlight structures to attract the consumers' eyes, increase their purchase desires and enhance the product competitiveness.

However, the commercially available nightlight is usually fixed to use a single usage type, which means that the nightlight can only be fixed in the plug socket and cannot be moved with the user.

Moreover, the lighting fixture with single function cannot attract the attention of the consumers gradually for the new and changing society. Therefore, how to provide a nightlight with an innovative structural design to further enhance its added value and taste is one of the most important topics at present.

### SUMMARY OF THE INVENTION

The main purpose of the present invention is to solve the problem that the conventional nightlight cannot be moved with the user.

Therefore, the present invention provides a separate rechargeable night light, which mainly includes: a nightlight holder; a shell body; an electricity contact terminal set on one side of the shell body for contacting to the socket of the mains supply to generate electricity; wherein the shell body is set with a rectifier circuit and a first contact switch, which the electricity contact terminal and the first contact switch are respectively electrically connected to the rectifier circuit; and a lighting fixture having a stereoscopic lamp housing and a charge-discharge circuit set inside the lamp housing; wherein the charge-discharge circuit includes a circuit board, a capacitor, and at least one light-emitting element, which a second contact switch is set on the bottom of the lamp housing; wherein the capacitor, the light-emitting element, and the second contact switch are electrically connected to the circuit board respectively and the lighting fixture can be separately connected to the first contact switch through the second contact switch.

In this way, the lighting fixture is operably separated from the nightlight holder to move with the user or served as an ornament to decorate the environment, and it still has the illumination effect by the electrical power storage characteristic of the capacitor when the lighting fixture leaves the nightlight holder.

### BRIEF DESCRIPTION OF THE DRAWINGS

FIG. 1 is a perspective view according to the present invention.

FIG. 2 is a decomposition schematic diagram according to the present invention.

FIG. 3 is a decomposition schematic diagram according to the present invention.

FIG. 4 is a schematic diagram in the using status according to the present invention.

FIG. 5 is a schematic diagram in the using status according to the present invention.

FIG. 6 is a schematic diagram of the electric circuit according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following detailed description provides a convenient illustration for implementing exemplary embodiments of the invention.

Various changes to the described embodiments may be made in the function and arrangement of the elements described without departing from the scope of the invention as set forth in the appended claims.

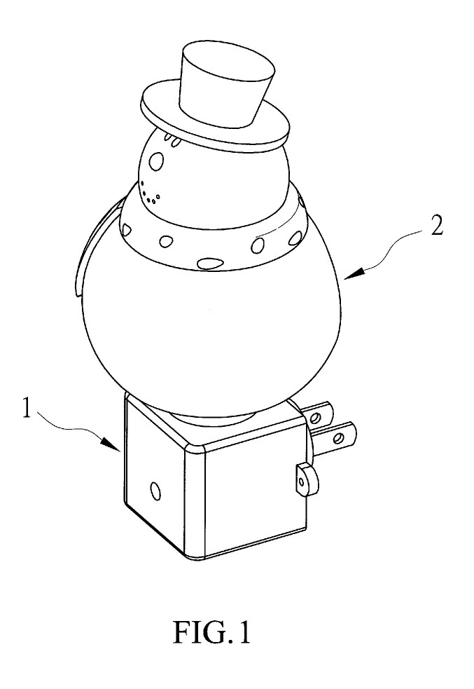

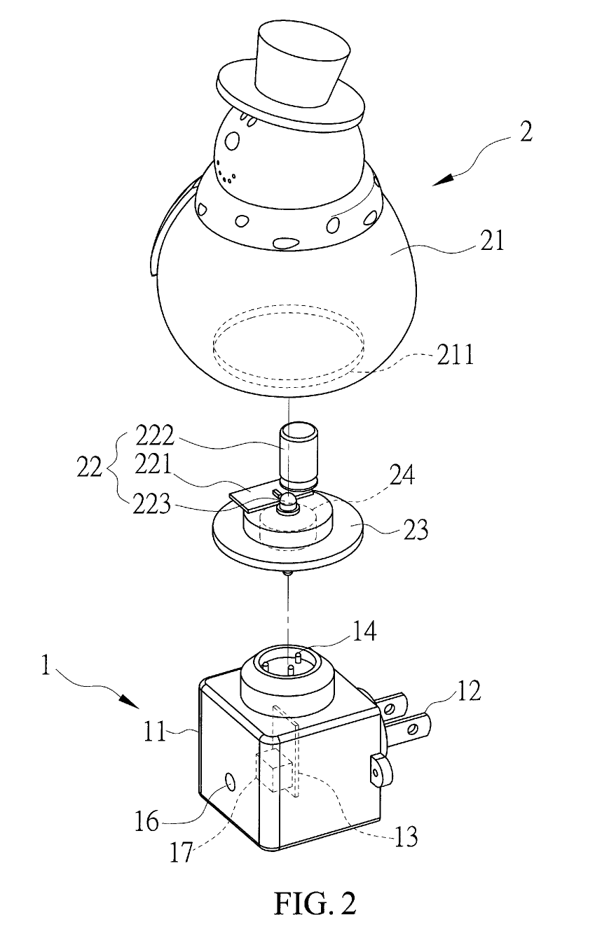

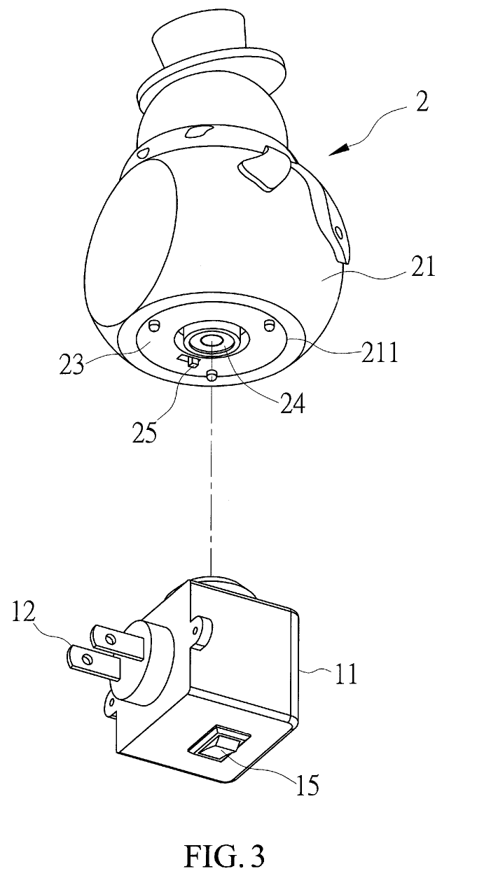

The following will be described with reference to the related figures, which illustrate a separable recharge nightlight according to a preferred embodiment of the present invention. As shown in FIG. 1 to FIG. 3, the separable recharge nightlight of the present invention mainly comprises a nightlight holder (1) and a lighting fixture (2) detachably connected to the upside of the nightlight holder (1), wherein: the nightlight holder (1) has a shell body (11) and an electricity contact terminal (12) set on one side of the shell body (11) for contacting to the socket of the mains supply to generate electricity. The housing (11) is provided with a rectifier circuit (13) and a first contact switch (14). The rectifier circuit (13) is fixed inside the shell body (11) and the first contact switch (14) is set on the top rim-side of the shell body (11); wherein the electricity contact terminal (12) and the first contact switch (14) are respectively electrically connected to the rectifier circuit (13).

The lighting fixture (2) has a stereoscopic lamp housing (21) and a charge-discharge circuit (22) set inside the lamp housing (21), wherein the lamp housing (21) is made of a light-transmitting material and an opening (211) which can be closed by a bottom cover (23) is set in the bottom of the lamp housing (21). The charge-discharge circuit (22) includes a circuit board (221), a capacitor (222), and at least one light-emitting element (223), wherein the circuit board (221) is fixed set on the bottom cover (23) and inside the lamp housing (21). The capacitor (222) and the light-emitting element (223) are set inside the lamp housing (21) and respectively electrically connected to the circuit board (221), wherein a second contact switch (24) is set on the outer edge of the bottom cover (23) to electrically connect with the circuit board (221). In the present embodiment, the second contact switch (24) is a magnetic contact switch which can be magnetically attracted to the first contact switch (14), whereby the lighting fixture (2) can be separately connected to the first contact switch (14) through the second contact switch (24).

The first contact switch (14) and the second contact switch (24) described herein are applications of general electronic components, so their features and structure will not be described in detail furthermore.

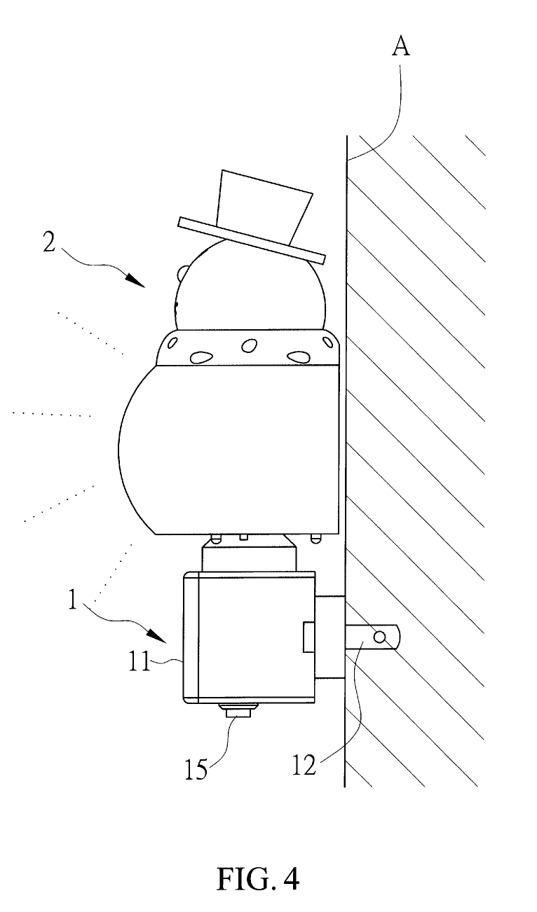

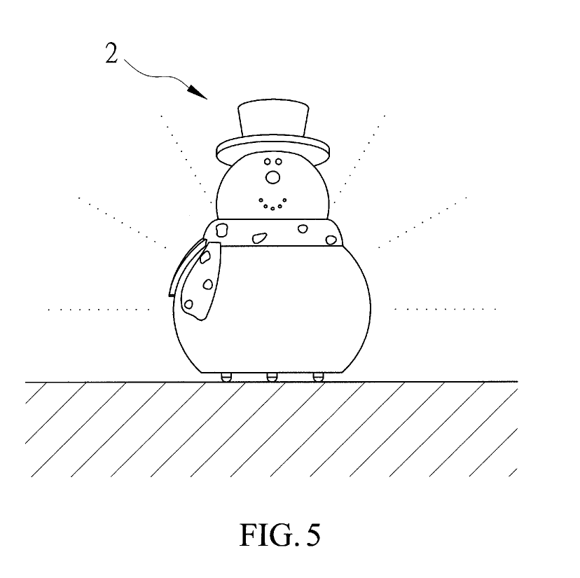

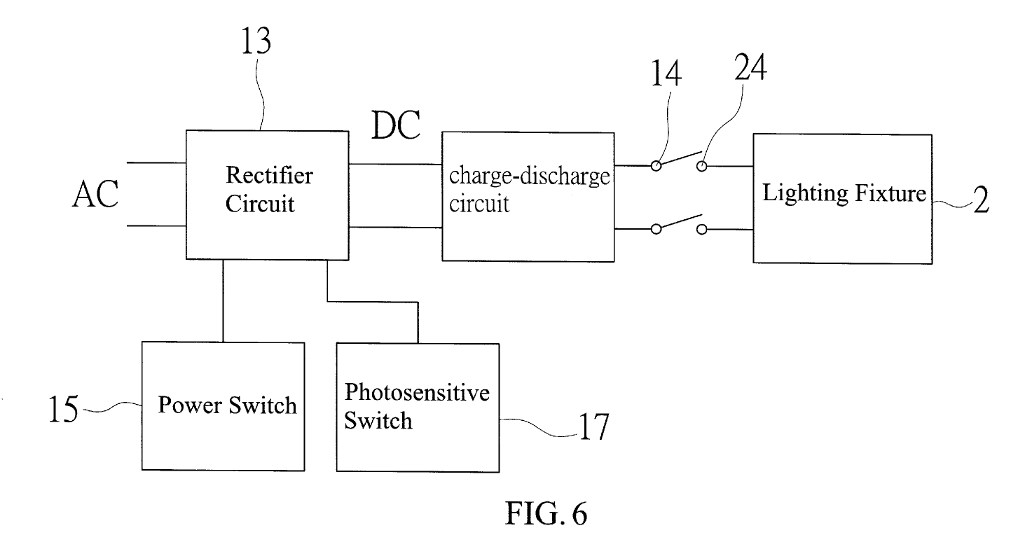

Continuously, as shown in FIG. 4 to FIG. 6, when the present invention is plugged into the socket of the wall surface (A) by using the electricity contact terminal (12), the AC current is converted to a DC current through the rectifier circuit (13) and entered into the charge-discharge circuit (22) to provide power for the light-emitting element (223) to generate light and provide illumination;

wherein part of the power will enter the capacitor (222) for storage.

Furthermore, since the second contact switch (24) of the lighting fixture (2) of the present invention is magnetically attached to the nightlight holder (1), the lighting fixture (2) an be separately taken off easily to move along with the user or just served as an ornament. When the lighting fixture (2) is detached from the nightlight holder (1), the power source of lighting fixture (2) is provided by the power stored in the capacitor (222), so that a light-control switch (25) is set on the bottom cover (23) for the user to separately control the lighting fixture (2) conveniently and the light-control switch (25) is electrically connected to the charge-discharge circuit (22) for controlling the on-off of the light-emitting element (223).

As stated above, in order for that the user does not need to dissemble the present invention from the wall surface (A) socket, a power switch (15) is further set at the outer edge of the nightlight holder (1), which the power switch (15) is electrically connected to the rectifier circuit (13) for opening and closing the mains supply. In this way, the present invention can be fixedly inserted on the wall surface (A), and the power switch (15) can be used to turn on the power.

Furthermore, a through hole (16) is set in the shell body (11) of the nightlight holder (1) and a photosensitive switch (17) is set corresponding to the through hole (16) to electrically connect with the rectifier circuit (13). In this way, the photosensitive switch (17) can detect the ambient light through the through hole (16) when the present invention is fixedly inserted into the socket, and when the ambient environment is dark, the photosensitive switch (17) will make the light-emitting element (223) automatically illuminate.

1. A separate rechargeable night light, which mainly comprises:
a nightlight holder; a shell body; an electricity contact terminal set on one side of the shell body adapted to electrically engage with a socket of an external electrical power supply to receive electricity therefrom; wherein the shell body is set with a rectifier circuit and a first contact, and the electricity contact terminal and the first contact are electrically connected to the rectifier circuit; and
a lighting fixture having a lamp housing and a charge-discharge circuit set inside the lamp housing; wherein the charge-discharge circuit includes a circuit board, a capacitor, and at least one light-emitting element, a second contact switch being set on the lamp housing; wherein the capacitor, the light-emitting element, and the second contact switch are electrically connected to the circuit board respectively and the lighting fixture is detachably connected to the nightlight holder with the first contact the second contact electrically engaging with each other;
wherein the lighting fixture is set with a light-control switch electrically connected to the charge-discharge circuit to control a supply of electricity to the light-emitting element and wherein the nightlight holder is set with a power switch electrically connected to the rectifier circuit to selectively supply the electricity received from the socket of the external power supply to the rectifier circuit;
wherein the nightlight holder and the lighting fixture are separable from each other such that the rectifier circuit that is arranged in the nightlight holder and the charge-discharge circuit arranged in the lighting fixture are separated from each other and respectively controllable by the light-control switch and the power switch.

2. The separate rechargeable night light according to claim 1, wherein the second contact is a magnetic contact attachable to the first contact through magnetic attraction therebetween.

3. (canceled)

4. The separate rechargeable night light according to claim 1, wherein the nightlight holder is set with a through hole and a photosensitive switch is set corresponding to the through hole and electrically connected with the rectifier circuit.

5. (canceled)
